(19) United States
(12) Patent Application Publication
(10) Pub. No.: US 2014/0257892 A1
(43) Pub. Date: Sep. 11, 2014

(54) SOCIAL PROJECT COLLABORATION THROUGH SELF-ORGANIZING TEAMS

(71) Applicant: INTERNATIONAL BUSINESS MACHINES CORPORATION, Armonk, NY (US)

(72) Inventors: Gregory T. Melahn, Apex, NC (US); Thomas Schaeck, Achern (DE)

(73) Assignee: INTERNATIONAL BUSINESS MACHINES CORPORATION, Armonk, NY (US)

(21) Appl. No.: 13/788,981

(22) Filed: Mar. 7, 2013

(51) Int. Cl. G06Q 50/00

(52) U.S. Cl. CPC G06Q 50/01; G06Q 10/103
USPC 705/7.13

(57) ABSTRACT

A graph of tasks and people operated on are incrementally created as nodes in a social network. Task nodes may be created in the social network to represent one or more tasks. A people node in the social network may follow other people nodes and also follow the one or more task nodes, and have one or more tasks associated with the task nodes assigned to one or more people nodes. Projects are run in a self-organizing way by operating on a graph of tasks and people that evolves over the course of the project representing the current state and upon completion representing the entire project state and history including all work results, tasks and people who contributed.

### FIELD

The present application relates generally to computers, and computer applications, and more particularly to project collaboration and management utilizing social networking mechanisms and technology.

### BACKGROUND

Project management may be viewed as a continuum. One side of the continuum has traditional top-down project management with a formal process where tasks are defined and scheduled, and then tasks are assigned to workers based on the workers' skills and availability. This traditional approach works well when someone takes on the role of a project manager, and where that project manager has experience in identifying the necessary tasks and dependencies, as well as monitoring the progress of the project based on projected completion times. In general, the traditional model assumes that the project manager has, at the inception of the project, a good understanding of what needs to be done and a set of known resources to accomplish it. Also, the project manager usually has some authority, directly or indirectly, over the project resources. This is a good model for known teams performing well understood tasks within a single company. An example of this model is the process used by a company for developing new products.

At the other end of the continuum is the ad-hoc model in which the initial high level goal is more loosely defined and requires further refinement in the process and usually the team itself is dynamic and it is initially unknown who will all be needed to get to complete. Team members may come and go and, typically, the team does not have a structure other than the fact that someone on the team may be elected as a chairperson, or designated as a coordinator. Most tasks are not defined at the beginning of the project. Instead, the team itself defines the tasks as they go along. Tasks are not typically assigned to workers but instead workers create tasks, give tasks, accept or volunteer for tasks. Often the workers have other jobs as well or work for different companies. So, one of the roles of the chairperson or coordinator may be to identify and convince someone to take on or volunteer for a task once it is identified. An example of this model is a standards committee developing a new specification, or a project where the project owner initiates the initial top level tasks and gives them to one or more initial participants, who can then proceed as they see fit.

### BRIEF SUMMARY

A method of social project collaboration in a self-organizing team, in one aspect, may comprise providing a plurality of project primitives for operating on one or more nodes of a social network. The nodes may represent users and tasks. The method may further comprise enabling adding of a task node representing a project task to the social network, from a people node representing a first user, using one or more of the plurality of project primitives. The method may also comprise enabling adding of one or more derived task nodes representing one or more tasks derived, directly or indirectly, from the project task to the social network, from one or more of people nodes representing one or more second users in the social network, using one or more of the plurality of project primitives. The method may further comprise enabling assigning of the project task and said one or more tasks derived from the project task to one or more of the first user or the second user, or combination thereof, using one or more of the plurality of project primitives. A graph comprising tasks, people, and relations associated with operations performed among the tasks and people, may be formed and grow as one or more of the plurality of project primitives are used to operate on the task node representing a project task, the one or more derived task nodes, the people node representing a first user, and the one or more of people nodes representing one or more second users in the social network.

A system for social project collaboration in a self-organizing team, in one aspect, may comprise a plurality of project primitives for operating on one or more nodes of a social network. The nodes may represent users and tasks. A module may be operable to execute on a processor and further operable to enable adding of a task node representing a project task to the social network, from a people node representing a first user, using one or more of the plurality of project primitives. The module may be further operable to enable adding of one or more derived task nodes representing one or more tasks derived directly or indirectly from the project task to the social network, from one or more of people nodes representing one or more second users in the social network, using one or more of the plurality of project primitives. The module may be further operable to enable assigning of the project task and the one or more tasks derived from the project task to one or more of the first user or the second user, or combination thereof, using one or more of the plurality of project primitives. The self-organizing team represented by a graph comprising tasks, people, and relations associated with operations performed among the tasks and people, may be formed and grow as one or more of the plurality of project primitives are used to operate on the task node representing a project task, the one or more derived task nodes, the people node representing a first user, and the one or more of people nodes representing one or more second users in the social network.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a diagram illustrating a social project collaboration and management model in one embodiment of the present disclosure.

FIG. 2 is a sample flow diagram showing how an initial task leads to a tree of other tasks in one embodiment of the present disclosure.

FIG. 3 is a flow diagram illustrating a method for self-organizing team in one embodiment of the present disclosure.

FIG. 4 illustrates a schematic of an example computer or processing system that may implement a system in one embodiment of the present disclosure.

### DETAILED DESCRIPTION

The present disclosure in one embodiment presents a model that is a blend of the business project management model and the ad-hoc model. The model of the present disclosure in one embodiment utilizes a social network that has developed between people within and/or between companies, and uses those network connections to enlist workers to reach a business goal or to complete a task.

Briefly, a social network may comprise a set of individuals or organizations or other entities or the like, and interactions among them, e.g., their relationships. Such social network may be provided in a form of a social networking or online community computing service, for example, over the Internet or another network, which enables individuals or the like to build relations among one another.

The approach presented in the present disclosure need not assume knowledge of the specific tasks or all of the specific tasks needed to accomplish a goal when the project begins. Instead it takes advantage of the knowledge, intelligence, and ingenuity of the team as the project evolves over time, it empowers people to help shape and run the project, rather than just executing some predefined tasks. The approach presented in the present disclosure in one embodiment also does not assume initial up-front knowledge of the resources available to accomplish the goal. Instead it uses the business and/or personal relationships embedded in social networks to reach and add new prospective team members as the evolving project requires. Still yet, the approach presented in the present disclosure may be based on a simple flow model that is easily understood by novices, encouraging adoption by users. The approach presented in the present disclosure in one embodiment may be based on a simple data model that can be easily used by application developers to integrate task management with many kinds of related applications.

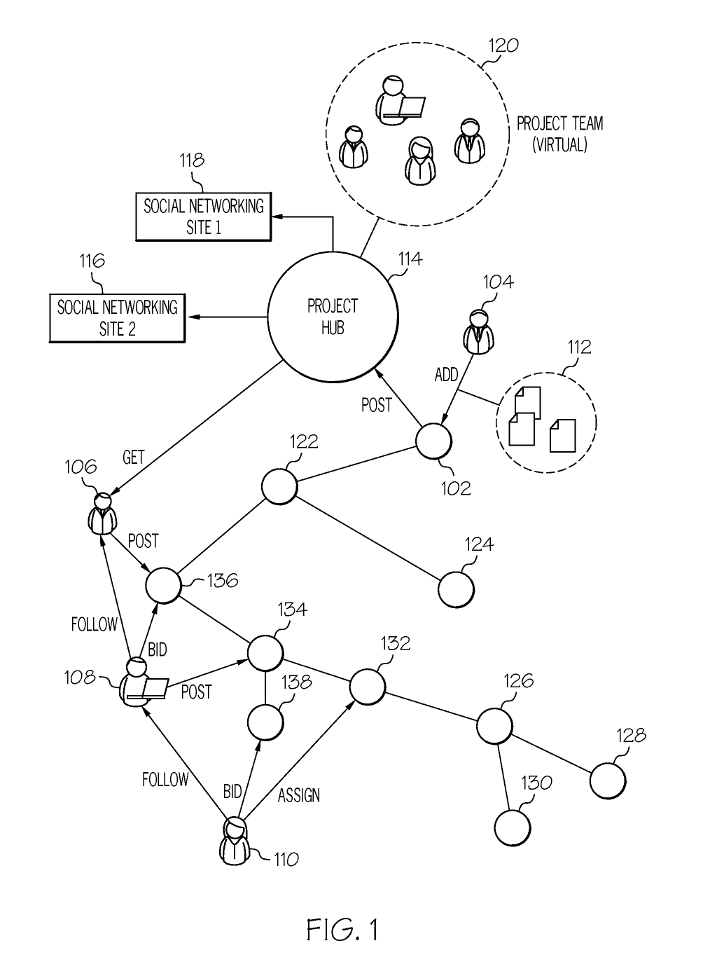

FIG. 1 is a diagram illustrating a project management model in one embodiment of the present disclosure. A project starts with a single task (e.g., 102). This single task results in other tasks, as the work needed to accomplish the goal is better understood and a progress is made. Thus, this initial task constitutes a kind of a seed, leading to a tree of new tasks. Persons (e.g., 104, 106, 108, 110) can create new tasks, join tasks, follow tasks, bid on tasks, work on tasks, complete tasks, abandon tasks, and/or perform other actions associated with tasks. As part of the work effort to complete a task, persons post content such as files (e.g., 112), and provide updates on effort by posting such events as hours worked or percentage of work done.

In one aspect, the project itself only exists as a project hub (e.g., 114) that knows what tasks are part of the project and can answer an activity stream to report overall status to anyone who asks for it. The project hub (e.g., 114) can be associated with a page on a social networking site (e.g., 116, 118), as can any task. Tasks can be managed on independent social networking sites that post back to the project hub (e.g., 114) when a state changes. The status is a feed showing the current status of each task. The project team (e.g., 120) itself is virtual, including one or more persons who have completed or are working on a task at any moment in time.

In one embodiment of the present disclosure, a model used is based on only three kinds of objects, Person (e.g., 104, 106, 108, 110), Task (e.g., 102, 122, 124, 126, 128, 130, 132, 135, 136, 138) and Project Hub (e.g., 114). Persons are human beings with a web identity. Examples of known web identifies include those associated with social networking sites and communities, microblogging sites, e.g., a FACEBOOK™ user, or a IBM CONNECTIOND™ user, TWITTER™ user, or the like. Any type of web identity may be utilized in the present disclosure. Tasks are web resources representing a goal to be accomplished, such as ‘Write a Book about Web Services’ or ‘Organize a Conference about Fermat's Last Theorem’. A Project Hub is a collection point for information related to a group of Tasks. Like Persons, a Project Hub may be associated with a web identity such as a FACEBOOK™ page.

A Self Organizing Team Project is bootstrapped when a Person starts the first Task (e.g., 102), and becomes its owner. At this point the initial Task is a description of the Goal of the Project. Then, other Persons who follow that Person see the existence of the Task and can offer to take a task or bid to become the person to be assigned the Task. Alternatively, the Task owner can offer or assign a Person a Task even without that Person bidding on the Task. The Task can be assigned in an automated way based on a policy. A Person who is assigned the Task owns the Task and is expected to complete it. To complete it, the Person may break down the Tasks into more Tasks and those new Tasks can be offered to others or bid on and assigned.

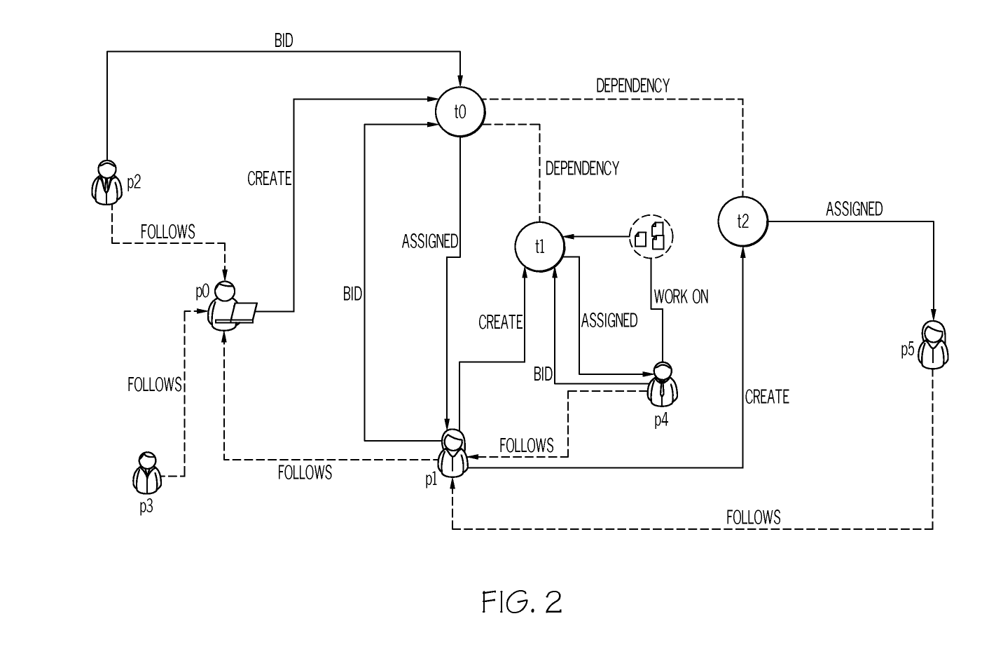

FIG. 2 is a sample flow diagram showing how an initial Task t0, leads to a tree of other tasks.

Assume the existence of Persons {p0, p1, p2, p3, p4, p5} in a social network. Suppose p1 follows p0, p2 follows p0, p3 follows p0, p3 follows p1, p4 follows p1, p5 follow p1. p0 creates t0. p1 follows p0, p2 follows p0, p3 follows p0, so p1, p2, p3 know about the existence of t0. p1 bids on t0, p2 bids on t0. p0 assigns t0 to p1. p1 creates t1 and t2 representing more tasks needed to accomplish the goals defined by t0. p4 follows p1, p5 follow p1, therefore, p4 and p5 know about the existence of t1 and t2. p4 bids on t1. p1 assigns t1 to p4. p4 works on t1 in the form of documents added to the task. No one has bid on t2, and p1 assigns t2 to one of his followers, p5. The flow continues until no more tasks are created and the last task is completed. Then the work is considered complete when the owner of task t0 marks it as complete.

An example implementation of the above-described model may define Persons, Tasks and the Project Hub using the objects defined by Activity Streams schema (Internet-Drafts of the Internet Engineering Task Force (IETF)) that defines a set of objects and verbs used in activity streams.

For example, the people in the project may be implemented using the Person object type defined by that Activity Streams schema as follows:

### Person

The “person” object type represents a user account. This often represents a person, but might also be a company or fictitious character that is being represented by a user account. In one embodiment, the person object may have the following properties:

| Property | Value | Description |
|---|---|---|
| displayName | JavaScript Object | A name that can be used for |
| | Notation (JSON) string | the person in the user |
| | | interface. This is often a name |
| | | by which the individual is |
| | | known in a given context; no |
| | | restriction is placed on what |
| | | kind of name may be used here. |
| Image | Media link | A link to an image |
| | | representing the person. |
| | | Processors MAY ignore |
| | | thumbnails that are of an |
| | | inappropriate size for |
| | | their user interface. |
| Id | JavaScript Object | The unique identifier |
| | Notation (JSON) string | for the person object. |
| Published | JavaScript Object | The optional time the person |
| | Notation (JSON) string | object was created in the form |
| | | of “date-time”. |
| Updated | JavaScript Object | The optional time the person |
| | Notation (JSON) string | object was last updated in the |
| | | form of “date-time”. |
| url | JavaScript Object | The permanent IRI of the |
| | Notation (JSON) string | person's HTML |
| | | representation |

In one embodiment, the Project Hub may be implemented using the Service object type defined by that Activity Streams schema as follows:

### Service

The “service” object type represents a website, personal website or blog, business, brand, or other entity that performs some kind of work for other entities, people, or services, or acts as kind of container for other objects. At a minimum, the service object has the following properties:

| Property | Value | Description |
|---|---|---|
| displayName | JavaScript Object | The natural-language, plain- |
| | Notation (JSON) string | text name of the service. |
| Id | JavaScript Object | The unique identifier for the |
| | Notation (JSON) string | service object. |
| Image | Media link | A link to a small image |
| | | representing the service. |
| Published | JavaScript Object | The optional time the service |
| | Notation (JSON) string | object was created in the |
| | | form of “date-time”. |
| Updated | JavaScript Object | The optional time the service |
| | Notation (JSON) string | object was last updated in the |
| | | form of “date-time”. |
| url | JavaScript Object | The permanent IRI of the |
| | Notation (JSON) string | service's HTML representation |

A Task object type may be introduced. The Task type may include properties like state, due date and status and may be extensible. One or more properties of Task may be calculated (e.g., accumulated hours). One or more properties of Task may be set to readonly (e.g., date created). One or more properties of Task may be set directly (e.g., due date). The model may also support links to associated media objects (e.g., specification files). A task object may be linked with a person object, for example, as a task object in the person's social networking site.

The standard set of verbs defined by the Request for Comments (RFC) from IETF may be supported, such as post, update, tag and others. In addition, a new set of verbs may be introduced to represent Self-Organizing Team actions. The new set of verbs may include bid, claim and complete. A mapping of the verbs to Task operations in one embodiment of the present disclosure is illustrated in Table 1.

TABLE 1
Example Mapping of Tasks to Activity Stream Verbs

| Task | Actor | Verb | Object | Target |
|---|---|---|---|---|
| Create a Task | Task Owner | Post | Task | Related Task |
| | | | | (optional for |
| | | | | dependency |
| | | | | tracking) |
| Assign a Task | Task Owner | Give | Task | Task Assignee |
| | | | | (a Person) |
| Bid on a Task | Anyone | Bid | Task | |
| Abandon a Task | Task Owner | Leave | Task | |
| Complete a Task | Task Owner | Complete | Task | |
| Claim a Task | Anyone | Claim | Task | |
| Do work on | Anyone who | Add | Object | Task |
| a Task | has joined | | | |
| | a Task | | | |
| Join a Task | Anyone | Join | Task | |
| Add a task | Task Owner | Add | Task | Service (the |
| to a Project | | | | Project Hub) |
| Follow status | Anyone | Follow | Service | |
| of a Project | | | | |

This table shows a partial mapping of Self-Organizing Team tasks to Activity Stream verbs. As mentioned earlier, some of the verbs are new (e.g., bid) and some are existing (e.g., follow). An approach like this allows social networking applications to create and consume Self-Organizing team content.

In one aspect, a project is represented through a social graph of people and tasks where each task is a first class social object that people can tag, like, follow, share, assign, sign up for, break down, or apply a process to, making tasks a natural part of a social graph of a social network. In another aspect, the social graph of the project over time captures all interactions and work results that people create in the course, so that a project can organically grow from an initial task to an eventually rich social graph representing the work results as well as the project that delivered it. Yet in another aspect, people can follow individual tasks or larger parts of the social graph representing a sub project or entire project to stay up to date on its individual or aggregated progress over time.

A project management infrastructure may be provided, e.g., with a project goal (task T) and a set of derived tasks, T1, T2, . . . , Tn. Assignments to the tasks may be supported, allowing for self-organizing teams by enabling people or users (P1, P2, . . . Pn) to operate on the set of derived tasks with project primitives. Examples of the project primitives includes, but are not limited to, create, join, follow, bid, post, work, complete, abandon, assign, claim, and others, which allows for a person Pi to operate on a task Tj. A Task Ti may comprise a work effort such as posting, adding files, updating files, indicating hours of work, indicating a percentage completed, and others. The tasks and actions may appear in an activity stream associated with at least one social networking site. A status operation on the project goal may be provided, for example, via information from the set of derived tasks.

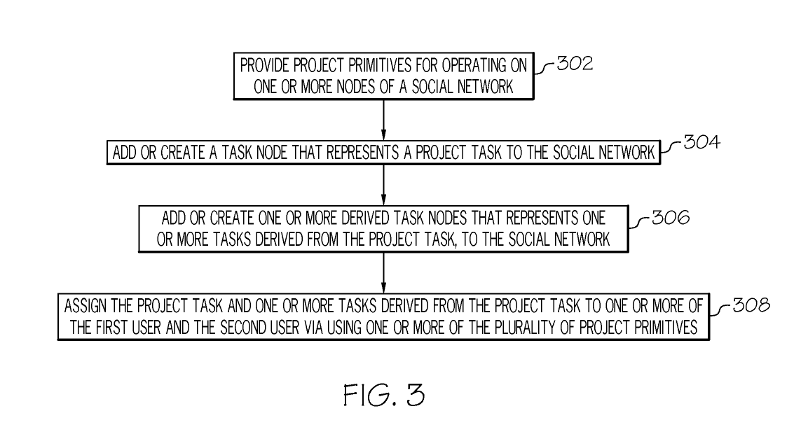

FIG. 3 is a flow diagram illustrating a method for social project collaboration in a self-organizing team in one embodiment of the present disclosure. At 302, project primitives are provided for operating on one or more nodes of a social network. For example, one or more nodes of the social network may include nodes that represent users and tasks.

At 304, adding or creating a task node that represents a project task, to the social network from a people node representing a first user may be enabled via using one or more of the plurality of project primitives.

At 306, adding or creating one or more derived task nodes that represents one or more tasks derived, e.g., directly or indirectly, from the project task, to the social network, e.g., from one or more of people nodes representing one or more second users in the social network, who may or may not be connected to the people node representing the first user, and/or from the people node representing the first user may be enabled via using one or more of the plurality of project primitives. For instance, the project task may be broken up into a group of tasks (or subtasks) and/or additional one or more tasks may be created that are related to the tasks. Such derived tasks are represented by derived task nodes connected to the social network.

At 308, assigning of the project task and the one or more tasks derived from the project task to one or more of the first user or the second user, or combination thereof, may be enabled via using one or more of the plurality of project primitives. For instance, assigning may be performed based on a project task or a derived task owner assigning the respective task to another user in the social network, or another user in the social network following the respective task, and for example, bidding on the respective task.

In this way, a graph comprising tasks, people, and relations associated with operations performed among the tasks and people, is formed and grows as the one or more of the plurality of project primitives are used to operate on the task node representing a project task, the one or more derived task nodes, the people node representing a first user, and the one or more of people nodes representing one or more second users in the social network.

In another aspect, a methodology of the present enables getting work done by representing a project large or small through a social graph of people, tasks, and work result objects such as texts, other documents, or other kinds of files, wherein each task is a social object that people can tag, like, follow, comment, share, assign, sign up for, break down, apply a process to, set target date and budget, set the amount of work done and/or amount of work remaining, set budget spent and/or remaining, add work result objects, hence making tasks a natural part of a social graph of a social network.

The social graph of tasks, people, and work results that represent the project over time, captures all interactions and work results that people create in the course of the project, for example, so that the project can organically grow from an initial task to an eventually rich social graph representing the work results as well as the project and people that delivered it, by incrementally adding people to tasks, who may add new tasks and work result objects to which in turn new people may be added who may create more related tasks and work results and so forth.

People who created tasks or otherwise have an interest can follow individual tasks or larger parts of the social graph representing a sub project or entire project, for example, to stay up to date on its individual or aggregated progress over time.

Self-organizing team, e.g., represented by a graph of tasks and people the team operates on are incrementally created as nodes in a social network. Task nodes may be created in the social network to represent one or more tasks. A people node in the social network may follow other people nodes and also follow the one or more task nodes, and have one or more tasks associated with the task nodes assigned to one or more people nodes. Projects are run in a self-organizing way by self-organizing teams operating on a graph of tasks and people that evolves over the course of the project representing the current state and upon completion representing the entire project state and history including all work results, tasks and people who contributed.

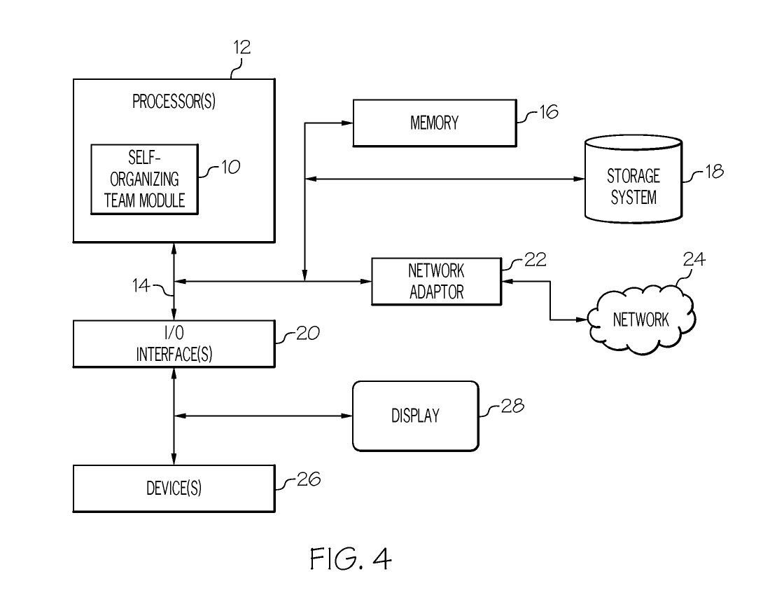

FIG. 4 illustrates a schematic of an example computer or processing system that may implement a system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 4 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a self-organizing team module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1.-12. (canceled)

13. A system for social project collaboration in a self-organizing team, comprising:
a processor;
a plurality of project primitives for operating on one or more nodes of a social network, said one or more nodes comprising nodes representing users and tasks;
a module operable to execute on the processor and further operable to enable adding of a task node representing a project task to the social network, from a people node representing a first user, using one or more of the plurality of project primitives,
the module further operable to enable adding of one or more derived task nodes representing one or more tasks derived directly or indirectly from the project task to the social network, from one or more of people nodes representing one or more second users in the social network, using one or more of the plurality of project primitives,
the module further operable to enable assigning of the project task and said one or more tasks derived from the project task to one or more of the first user or the second user, or combination thereof, using one or more of the plurality of project primitives,
wherein a graph comprising tasks, people, and relations associated with operations performed among the tasks and people, is formed and grows as said one or more of the plurality of project primitives are used to operate on the task node representing a project task, said one or more derived task nodes, the people node representing a first user, and said one or more of people nodes representing one or more second users in the social network.

14. The system of claim 13, wherein the plurality of project primitives comprises one or more of create, join, follow, give, bid, claim, post, work, complete, abandon, assign, tag, like, share, sign up for, break down, or apply a process to, or combinations thereof.

15. The system of claim 13, wherein the module is further operable to enable adding one or more work result objects to the social network as an additional node.

16. The system of claim 15, wherein the task node representing a project task, said one or more derived task nodes, the people node representing a first user and said one or more of people nodes representing one or more second users, and the work result objects in the social network capture information associated with the project task over time.

17. The system of claim 13, wherein the module is further operable to enabling creating of a project hub node in the social network, the project hub node representing a project hub, to which the task node representing a project task, said one or more derived task nodes, the people node representing a first user, and said one or more of people nodes representing one or more second users, add information associated with the project task.

18. A computer readable storage medium storing a program of instructions executable by a machine to perform a method of social project collaboration in a self-organizing team comprising:
providing a plurality of project primitives for operating on one or more nodes of a social network, said one or more nodes comprising nodes representing users and tasks;
enabling adding of a task node representing a project task to the social network, from a people node representing a first user, using one or more of the plurality of project primitives;
enabling adding of one or more derived task nodes representing one or more tasks derived directly or indirectly from the project task to the social network, from one or more of people nodes representing one or more second users in the social network, using one or more of the plurality of project primitives; and
enabling assigning of the project task and said one or more tasks derived from the project task to one or more of the first user or the second user, or combination thereof, using one or more of the plurality of project primitives,
wherein a graph comprising tasks, people, and relations associated with operations performed among the tasks and people, is formed and grows as said one or more of the plurality of project primitives are used to operate on the task node representing a project task, said one or more derived task nodes, the people node representing a first user, and said one or more of people nodes representing one or more second users in the social network.

19. The computer readable storage medium of claim 18, wherein the plurality of project primitives comprises one or more of create, join, follow, give, bid, claim, post, work, complete, abandon, assign, tag, like, share, sign up for, break down, or apply a process to, or combinations thereof.

20. The computer readable storage medium of claim 18, wherein each of the task node and the one or more derived task nodes, is implemented as a web page on a social network site, which one or more of said first user or said second users, or combination thereof, follow via said one or more of the plurality of project primitives.
